(19) United States
(12) Patent Application Publication
(10) Pub. No.: US 2016/0097232 A1
(43) Pub. Date: Apr. 7, 2016

(54) PAPER CURRENCY STORAGE DEVICE AND METHOD OF USE

(71) Applicant: Tracy Spencer, Wixon, MI (US)

(72) Inventors: Irma Thrower, Wixon, MI (US); Tracy Spencer, Wixon, MI (US)

(21) Appl. No.: 14/872,651

(22) Filed: Oct. 1, 2015

Related U.S. Application Data
(60) Provisional application No. 62/058,168, filed on Oct. 1, 2014.

(51) Int. Cl. E05G 1/024

(52) U.S. Cl. CPC E05G 1/024

(57) ABSTRACT

A paper currency saving device that includes: a housing, where the housing includes a plurality of sides; an opening in one of the plurality of sides, where the opening enables paper currency to pass into the housing; and a plurality of tiles on the housing, where the plurality of tiles are arranged to completely cover the housing. The housing may be cuboidal in shape and include a first lateral side, a second lateral side, a top side, a bottom side, a front face and a back face.

### CROSS REFERENCE TO OTHER APPLICATIONS

This application claims priority to U.S. Provisional Application Ser. No. 62/058,168 filed on Oct. 1, 2014.

### BACKGROUND OF THE INVENTION

1. Field of the Invention

The present invention relates to a device to house a user's money, where the device enables insertion of paper currency but prevents withdrawal until the device is broken.

2. Description of Related Art

Smart money practices are skills imperative to establishing a stable and successful living. Parents or guardians might start teaching their children about money and saving by giving them an allowance. The child must perform a task, and after completion the child receives payment for their services. A savings habit may be developed by using a piggy bank or bedroom drawer for savings until the child has accumulated enough to purchase an item. Over time the child learns how much money is needed or must be saved for the toys, treats or luxuries they desire.

This concept easily translates into the real world where work provides a salary and money for spending purposes. Many people choose to deposit their money into a bank for safe keeping and accumulation. However the cash may be easily withdrawn by going to the bank or teller machine, or using a debit card to directly pay a business from their bank account. Alternatively, some people like to keep their money readily on hand, thus choosing to store their money in a safe place at their home. They may hide their money under the mattress, in a box in the closet, or in a home safe. This permits them to have cash readily available whenever needed. While having the money on hand whenever wanted is convenient, it may be too easily accessed and lead to unwise spending. Because the money is so easy to grab the person may spend frivolously or on unnecessary items. Keeping their money in a bank provides an additional shield to obtaining the money, but it is not always convenient to deposit money at financial institution as often as simply storing at home.

Therefore it would be beneficial in the art to provide a device that provides the convenience storing money in a home safe while also protecting the money saved. It would also be desirable in the art to provide a device that is decorative to blend into the decor and ambiance of the home.

### SUMMARY OF THE INVENTION

The present invention relates to a paper currency saving device that includes: a housing, where the housing includes a plurality of sides; an opening in one of the plurality of sides, where the opening enables paper currency to pass into the housing; and a plurality of tiles on the housing, where the plurality of tiles are arranged to completely cover the housing. The housing may be cuboidal in shape and include a first lateral side, a second lateral side, a top side, a bottom side, a front face and a back face.

### BRIEF DESCRIPTION OF THE DRAWINGS

The advantages and features of the present invention will become better understood with reference to the following detailed description and claims taken in conjunction with the accompanying drawing and in which:

FIG. 1 depicts a perspective view of a paper currency saving device in accordance with an exemplary embodiment of the present invention.

### DETAILED DESCRIPTION OF THE DRAWINGS

The present invention relates to a device to house a user's money, where the device enables insertion of the paper currency but prevents withdrawal until the device is broken. The present invention provides a paper currency saving device to prevent frivolous spending. The paper currency saving device is a generally cuboidal structure with a thin slot on one side. The user is able to insert paper or coin money into the slot, but is unable to retrieve the money after insertion. In order to retrieve the paper currency the user must break or shatter the device. The paper currency saving device forces the user to weigh the consequence of accessing and spending the money thereby furthering their wise money saving decisions.

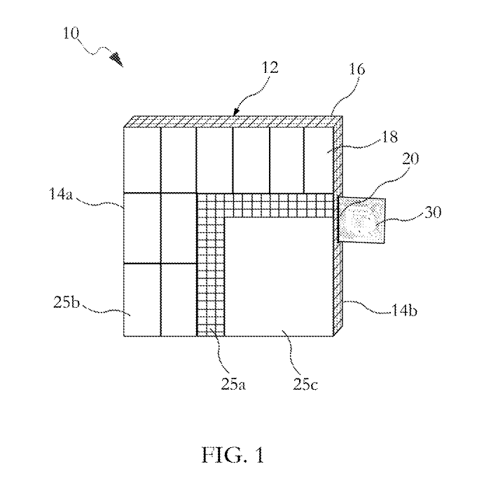

Turning now descriptively to the drawing, referring to FIG. 1, a perspective view of a paper currency saving device 10 in accordance with an exemplary embodiment of the present invention. The paper currency saving device 10 comprises a housing 12. The housing 12 may be cuboidal with a pair of lateral sides 14a, 14b, a top side 16, a bottom side, a front face 18 and a back face. Alternatively, the housing 12 may be cylindrical, spherical or any other voluminous shapes preferred by the user. The housing 12 may range in size from 6-24 inches in height, 6-24 inches in length and 1-6 inches in width; preferably, the housing 12 measures 12 inches in height, 12 inches in length, and 2 inches in width.

On one of the lateral sides 14b may be an opening 20. The opening 20 may also be positioned on the top side 16. The opening 20 is a thin slot that enables a paper bill to be inserted into the housing 12. The housing 12 does not include any other openings or passages through which to gain access to the inserted paper currency, therefore once the bills are deposited they cannot be retrieved. To acquire the paper currency, the user must break open the housing 12. This provides a barrier between the user and the money, thereby preventing frivolous and wasteful spending.

The housing 12 may have a decorative appearance for an appealing aesthetic. The housing 12 may be covered with a plurality of tiles 25. The tiles may be available in as small 25a, medium 25b, or large 25c tiles. The small tiles 25a may be small individual ceramic, glass, marble or wood pieces that create a mosaic design on the housing 12. The small tiles 25a may be arranged on sheets and then placed on the housing 12. The medium 25b and large tiles 25c may be wood, glass, ceramic, marble or granite. The tiles 25 may be arranged as preferred by the user. Likewise, the tiles 25 may be arranged to disguise the housing 12 into a furniture or wall piece of the user's home or office. This way the housing 12 is camouflaged preventing theft of the inner contents. With the paper currency saving device 10 the user is afforded a convenient money saving tool that promotes saving while also promoting smart spending.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A paper currency saving device comprising:
a. a housing, where the housing includes a plurality of sides;
b. an opening in one of the plurality of sides, where the opening enables paper currency to pass into the housing; and
c. a plurality of tiles on the housing, where the plurality of tiles are arranged to completely cover the housing.

2. The paper currency saving device according to claim 1, where the housing cuboidal in shape and includes a first lateral side, a second lateral side, a top side, a bottom side, a front face and a back face.

3. The paper currency saving device according to claim 2, where the opening is on the first lateral side.

4. The paper currency saving device according to claim 2, where the opening is on the second lateral side.

5. The paper currency saving device according to claim 2, where the opening is on the top side.

6. The paper currency saving device according to claim 1, where the opening is a thin slot.

7. The paper currency saving device according to claim 1, the housing is impregnable.

8. The paper currency saving device according to claim 1, where the plurality of tiles is made of at least one of ceramic, glass, marble or wood.

9. The paper currency saving device according to claim 8, where the plurality of tiles create a mosaic design.
